(19) United States
(12) Patent Application Publication
(10) Pub. No.: US 2023/0336468 A1
(43) Pub. Date: Oct. 19, 2023

(54) Packet-Based Network Delivery Control

(71) Applicant: AT&T Intellectual Property I, L.P., Atlanta, GA (US)

(72) Inventors: Adam Christa, Plano, TX (US); Ayman Braik, Dallas, TX (US); Chelby Rhoades, Dallas, TX (US); Morgan Muir, Dallas, TX (US); Sarah Witt, Dallas, TX (US); Eric Zavesky, Austin, TX (US); Gargi Kand, San Jose, CA (US)

(73) Assignee: AT&T Intellectual Property I, L.P., Atlanta, GA (US)

(21) Appl. No.: 17/719,807

(22) Filed: Apr. 13, 2022

(51) Int. Cl. H04L 45/42; H04L 45/302; H04L 45/02; H04L 9/40

(52) U.S. Cl. CPC H04L 45/42; H04L 45/3065; H04L 45/02; H04L 63/20

(57) ABSTRACT

Packet-based network delivery control can include receiving, at a router of a network route, data packets associated with traffic generated by an application server, the traffic being sent by an application server to a destination device via the network route, determining, at the router, if executable code is to be generated for the data packets, in response to a determination that the executable code is to be generated for the data packets, determining handling instructions for the data packets, generating the executable code, the executable code, when executed by the router, causing the router to transmit the data packets across the network route in accordance with the handling instructions, and implementing the handling instructions at the router to transmit the data packets across the network route in accordance with the handling instructions.

### BACKGROUND

When purchasing Internet access, a customer may pay for a particular quality of service (“QoS”) such as, for example, a certain speed of the connection, a specified latency of the connection, or the like. Based on network conditions at any particular time, however, and particularly based on the general fluctuation in network capacity and demand over time, customers may at times realize a QoS that is less than the QoS commitment paid for by the customer. This can adversely affect customer satisfaction with their network provider.

In general, when packets and/or other forms of data are sent from an originating device to a destination device and traverse a network (e.g., the Internet), the packets generally will traverse the protocol stack on the originating device (e.g., a client machine) and then hop through routers up to the network level. The routers along the path to the destination device generally function by receiving the packets, determining the destination from the header of the packets, accessing a lookup table to identify a next hop from the table based on the destination device specified, and forwarding the packets to the router associated with the next hop. As such, routers simply forward packets based on data in their headers and a table lookup.

The operations of receiving the packets, identifying the destination from the headers, and performing the table lookup can be time consuming and therefore can cause congestion in the network. Such congestion can adversely affect perceived QoS and resulting customer satisfaction.

### SUMMARY

The present disclosure is directed to packet-based network delivery control. QoS-related handling instructions and other handling instructions (e.g., multiplexing/de-multiplexing instructions; security settings, configurations, and/or protocols to be used for routing; network topologies and/or topology changes to implement for routing; priority settings and/or other QoS settings and/or configurations; combinations thereof; or the like) can be represented by executable code that can be embedded in packets and transmitted as part of the packets. Routers in the network can be configured to recognize the executable code and implement the code to handle the packets in accordance with the handling instructions represented by the code. In some embodiments of the concepts and technologies disclosed herein, packets can be received from any application and one or more of the routers of the network can be configured to generate the executable code to embed in the packets (e.g., as a part of the payload of the packets and/or elsewhere). Alternatively, applications and/or services can create the executable code at other times such as, for example, the application that is generating the packets can generate the executable code as part of the packets, or the like. The routers can be configured to execute the code to optimize the handling of the packets in accordance with the code.

A server application can generate and/or transmit data packets to one or more destination devices via a network route. The network route can include one or more routers. The routers that correspond to the network route can be configured in some embodiments to access the server computer via an API and/or other functionality. The application server, the routers, and/or the server computer can host and/or execute a packet management module, packet management application, and/or packet management service that can be configured to determine handling instructions for the data packets when traversing the network route, to generate executable code that captures these handling instructions, and to embed or append the code to the data packets. The code can be executable by the routers and/or other network devices to alter handling of the data packets by the routers. In some example embodiments, the network route can be altered to impose security protocols and/or configurations based on the code; to have its topology altered based on the code (e.g., via calling the packet management service and/or the orchestration service); to have operations of the routers altered based on the code (e.g., multiplexing, de-multiplexing, capacity changes, quality of service (“QoS”) changes, etc.); and/or the like.

In some embodiments, the application server can execute the package management module and the packet management module can generate and embed the code in the data packets before transmission. In some other embodiments, the routers can execute the package management module and/or similar functionality and the routers can generate and embed the code in the data packets after receipt. In yet other embodiments, the routers can be configured to call functionality of a packet management service and/or other functionality for generating and/or embedding the code in the data packets and the server computer, the orchestration service, and/or the routers can be configured to implement operations as directed by the code.

The code included in the data packets can be implemented by the routers in some embodiments to alter the configuration of the routers. Thus, the code can cause the routers to modify how traffic is routed by the routers, to activate and/or deactivate multiplexing and/or de-multiplexing, to apply security configurations and/or protocols to the traffic associated with the data packets, and/or to otherwise alter the operation of the routers. In some embodiments, the orchestration service can be configured to alter a network topology (e.g., instantiating, deactivating, and/or modifying network devices or functions) and/or functions of the existing network topology based on the code. The orchestration service can be called, in some embodiments, by the packet management module, by the packet management service, and/or by the routers. The routers and/or the orchestration service can implement the handling instructions, route and/or otherwise handle the data packets in accordance with handling instructions, and provide feedback in some embodiments to the packet management service.

In some embodiments, the packet management service can access one or more packet management models to determine handling instructions for the data packets. The packet management models can be used to reflect how similar or identical traffic has been routed in the past, in some embodiments, or to define handling instructions for some types of traffic (regardless of past handling). Thus, the packet management service and/or the packet management module can be configured to route traffic based on independent determinations relating to the data packets and/or based on the packet management models. It should be understood that this example is illustrative, and therefore should not be construed as being limiting in any way.

The data packets can be routed to the one or more destination devices by the routers and feedback can be provided to the packet management service. In some embodiments, the packet management service can update the packet management models. Thus, it can be appreciated that the data packets can include code that can alter execution of devices and/or functions associated with a network route and that the packet management models can be updated based on the handling of the data packets. It should be understood that this example is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include receiving, at a router included in a network route, data packets associated with traffic generated by an application server, wherein the traffic is sent by an application server to a destination device via the network route, determining, at the router, if executable code is to be generated for the data packets, in response to a determination that the executable code is to be generated for the data packets, determining handling instructions for the data packets, generating the executable code, wherein the executable code, when executed by the router, causes the router to transmit the data packets across the network route in accordance with the handling instructions, and implementing the handling instructions at the router to transmit the data packets across the network route in accordance with the handling instructions.

In some embodiments, the computer-executable instructions, when executed by the processor, can cause the processor to perform operations further including embedding the executable code in the data packets by adding the executable code to the payloads of the data packets. In some embodiments, the handling instructions can include an indication of a quality of service to apply to transmission of the data packets across the network route. In some embodiments, the handling instructions can include a first instruction to multiplex at least two of the data packets at the router to obtain a data package, and a second instruction to de-multiplex the data package at a further router included in the network route. In some embodiments, the handling instructions can include a security configuration to apply across the network route for the data packets, wherein the security configuration can include a security protocol.

In some embodiments, the handling instructions can include a network topology to use for the network route, wherein the router can invoke a packet management service via an application programming interface to cause the packet management service to trigger a topology change along the network route. In some embodiments, the topology change is implemented by an orchestration service in communication with the packet management service. In some embodiments, generating the executable code can include requesting, via an application programming interface exposed by a computing device, a packet management service to provide the executable code. In some embodiments, the packet management service generates the executable code based on an analysis of the data packets and a packet management model that defines handling instructions for a traffic type associated with the data packets.

According to another aspect of the concepts and technologies disclosed herein, a method is disclosed. The method can include receiving, at a router included in a network route, data packets associated with traffic generated by an application server, wherein the traffic is sent by an application server to a destination device via the network route; determining, at the router, if executable code is to be generated for the data packets; in response to a determination that the executable code is to be generated for the data packets, determining handling instructions for the data packets; generating the executable code, where the executable code, when compiled or executed by the router, causes the router to transmit the data packets across the network's route in accordance with the handling instructions provided in the executable code; and implementing the handling instructions at the router to transmit the data packets across the network route in accordance with the handling instructions.

In some embodiments, the method further can include embedding the executable code in the data packets by adding the executable code to the payloads of the data packets. In some embodiments, the handling instructions can include a network topology to use for the network route, wherein the router invokes a packet management service via an application programming interface to cause the packet management service to trigger a topology change along the network route, and wherein the topology change is implemented by an orchestration service in communication with the packet management service. In some embodiments, generating the executable code can include requesting, via an application programming interface exposed by a computing device, a packet management service to provide the executable code, and wherein the packet management service generates the executable code based on an analysis of the data packets and a packet management model that defines handling instructions for a traffic type associated with the data packets.

According to yet another aspect of the concepts and technologies disclosed herein, a computer storage medium is disclosed. The computer storage medium can store computer-executable instructions that, when executed by a processor, cause the processor to perform operations. The operations can include receiving, at a router included in a network route, data packets associated with traffic generated by an application server, wherein the traffic is sent by an application server to a destination device via the network route; determining, at the router, if executable code is to be generated for the data packets; in response to a determination that the executable code is to be generated for the data packets, determining handling instructions for the data packets; generating the executable code, wherein the executable code, when executed by the router, causes the router to transmit the data packets across the network route in accordance with the handling instructions; and implementing the handling instructions at the router to transmit the data packets across the network route in accordance with the handling instructions.

In some embodiments, the computer-executable instructions, when executed by the processor, can cause the processor to perform operations further including embedding the executable code in the data packets by adding the executable code to the payloads of the data packets. In some embodiments, the handling instructions can include an indication of a quality of service to apply to transmission of the data packets across the network route. In some embodiments, the handling instructions can include a first instruction to multiplex at least two of the data packets at the router to obtain a data package, and a second instruction to de-multiplex the data package at a further router included in the network route.

In some embodiments, the handling instructions can include a security configuration and/or security protocols to apply across the network route for the data packets. In some embodiments, the handling instructions can include a network topology to use for the network route, wherein the router invokes a packet management service via an application programming interface to cause the packet management service to trigger a topology change along the network route, and wherein the topology change is implemented by an orchestration service in communication with the packet management service. In some embodiments, generating the executable code can include requesting, via an application programming interface exposed by a computing device, a packet management service to provide the executable code, and wherein the packet management service generates the executable code based on an analysis of the data packets and a packet management model that defines handling instructions for a traffic type associated with the data packets.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for implementing packet-based traffic control at an application server, according to an illustrative embodiment of the concepts and technologies described herein.

FIG. 3 is a flow diagram showing aspects of a method for implementing packet-based traffic control at a network router, according to an illustrative embodiment of the concepts and technologies described herein.

FIG. 4 is a flow diagram showing aspects of a method for implementing packet-based traffic control using a packet management service, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to enable packet-based network delivery control, according to some illustrative embodiments of the concepts and technologies described herein.

FIG. 7 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to packet-based network delivery control. A server application can generate and/or transmit data packets to one or more destination devices via a network route. The network route can include one or more router. The routers that correspond to the network route can be configured in some embodiments to access the server computer via the API and/or other functionality. The application server, the routers, and/or the server computer can host and/or execute a packet management module, packet management application, and/or packet management service that can be configured to determine handling instructions for the data packets when traversing the network route, to generate executable code that captures these handling instructions, and embedding or appending the code to the data packets. The code can be executable by the routers and/or other network devices to alter handling of the data packets by the routers. In some example embodiments, the network route can be altered to impose security protocols and/or configurations based on the code; to have its topology altered based on the code (e.g., via calling the packet management service and/or the orchestration service); to have operations of the routers altered based on the code (e.g., multiplexing, de-multiplexing, capacity changes, QoS changes, etc.); and/or the like.

In some embodiments, the application server can execute the package management module and the packet management module can generate and embed the code in the data packets before transmission. In some other embodiments, the routers can execute the package management module and/or similar functionality and the routers can generate and embed the code in the data packets after receipt. In yet other embodiments, the routers can be configured to call functionality of a packet management service and/or other functionality for generating and/or embedding the code in the data packets and the server computer, the orchestration service, and/or configured to implement operations as directed by the code.

The code included in the data packets can be implemented by the routers in some embodiments to alter the configuration of the routers. Thus, the code can cause the routers to modify how traffic is routed by the routers, to activate and/or deactivate multiplexing and/or de-multiplexing, to apply security configurations and/or protocols to the traffic associated with the data packets, and/or to otherwise alter the operation of the routers. In some embodiments, the orchestration service can be configured to alter a network topology (e.g., instantiating, deactivating, and/or modifying network devices or functions) and/or functions of the existing network topology based on the code. The orchestration service can be called, in some embodiments, by the packet management module, by the packet management service, and/or by the routers. The routers and/or the orchestration service can implement the handling instructions, route and/or otherwise handle the data packets in accordance with handling instructions, and provide feedback in some embodiments to the packet management service.

In some embodiments, the packet management service can access one or more packet management models to determine handling instructions for the data packets. The packet management models can be used to reflect how similar or identical traffic has been routed in the past, in some embodiments, or to define handling instructions for some types of traffic (regardless of past handling). Thus, the packet management service and/or the packet management module can be configured to route traffic based on independent determinations relating to the data packets and/or based on the packet management models. It should be understood that this example is illustrative, and therefore should not be construed as being limiting in any way.

The data packets can be routed to the one or more destination devices by the routers and feedback can be provided to the packet management service. In some embodiments, the packet management service can update the packet management models. Thus, it can be appreciated that the data packets can include code that can alter execution of devices and/or functions associated with a network route and that the packet management models can be updated based on the handling of the data packets. It should be understood that this example is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

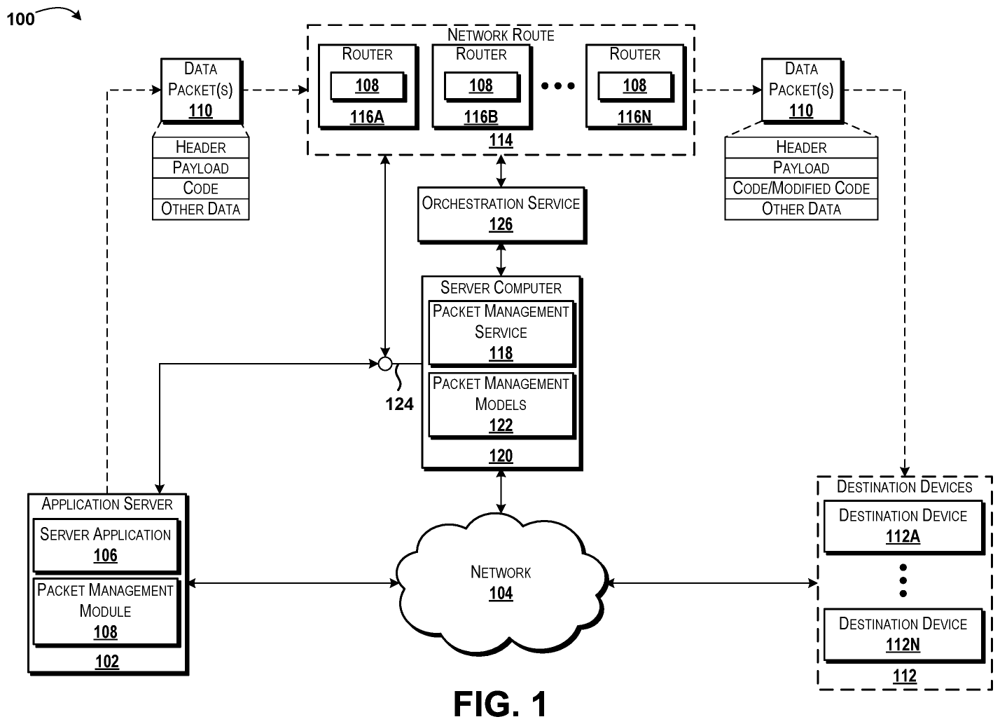

Referring now to FIG. 1, aspects of an operating environment 100 for various embodiments of the concepts and technologies disclosed herein for packet-based network delivery control will be described, according to an illustrative embodiment. The operating environment 100 shown in FIG. 1 includes an application server 102. The application server 102 can operate in communication with and/or as part of a communications network (“network”) 104, though this is not necessarily the case.

According to various embodiments, the functionality of the application server 102 may be provided by one or more real or virtual computing devices such as server computers, desktop computers, mobile telephones, laptop computers, other computing systems, and the like. It should be understood that the functionality of the application server 102 may be provided by a single device, by two or more similar devices, and/or by two or more dissimilar devices. For purposes of describing the concepts and technologies disclosed herein, the application server 102 is described herein as a server computer. It should be understood that this embodiment is illustrative and should not be construed as being limiting in any way.

The application server 102 can execute an operating system (not shown in FIG. 1) and one or more application programs such as, for example, a server application 106 and a packet management module 108. The operating system can include a computer program that can control the operation of the application server 102. The server application 106 and the packet management module 108 can include executable programs that can be configured to execute on top of the operating system to provide various functions as illustrated and described herein.

The server application 106 can correspond to almost any type of application, service, or module. In particular, the server application 106 can correspond to functionality hosted and/or provided by the application server 102 for one or more users. For example, if the application server 102 is associated with a banking service, the server application 106 can correspond to a banking application, module, program, service or the like. Thus, the functionality of the server application 106 can include almost any functionality in accordance with various embodiments of the concepts and technologies disclosed herein. In other embodiments, the functionality of the application server 102 may reside partially on a user's device or user application. For example, part of a banking application may be executed on a user's mobile device. Within this execution, the banking application may consider certain communication attempts as high priority, as requiring extra security, or as data that is to be broadcasted to multiple recipients. For purposes of illustrating and describing the concepts and technologies disclosed herein, the server application 106 illustrated and described herein is assumed to generate one or more data packets 110 associated with network traffic, where the traffic is generated and/or transmitted for eventual delivery to one or more destination devices 112A-N (hereinafter collectively and/or generically referred to as “destination devices 112”) via a network route 114 that can include one or more routers 116A-N (hereinafter collectively and/or generically referred to as “routers 116”). These and other aspects of the concepts and technologies disclosed herein will be illustrated and described in more detail hereinbelow.

In the Illustrated embodiment, the packet management module 108 is illustrated as being executed and/or hosted by the application server 102 and/or one or more of the routers 116. As will be explained in more detail herein, the packet management module 108 and/or substantially similar applications, modules, programs, services, or the like such as a packet management service 118 can be hosted and/or executed by various devices according to embodiments of the concepts and technologies disclosed herein such as, for example, the application server 102, the routers 116, one or more server computers 120, other devices, or the like. Thus, it can be appreciated that various embodiments of the concepts and technologies disclosed herein can be configured to provide the functionality illustrated and described herein for packet-based network delivery control via one or more devices.

In particular, in some embodiments of the concepts and technologies disclosed herein, the application server 102 can execute the packet management module 108 to monitor traffic (e.g., one or more of the data packets 110) generated and/or transmitted by the server application 106. Thus, the packet management module 108 can be configured to monitor traffic associated with the server application 106 and to determine one or more handling instructions for the traffic (and/or one or more of the data packets 110 of the traffic). As used herein, the handling instructions can identify one or more destination devices 112 associated with the traffic; one or more communication settings and/or configurations that should be used along one or parts of the network route 114; one or more security settings and/or configurations that should be implemented along the network route 114 and/or portions thereof; one or more multiplexing and/or de-multiplexing operations that should be performed on one or more of the data packets 110 along the network route 114; combinations thereof; or the like. In some embodiments, the server application 106 can define one or more of the handling instructions and the packet management module 108 can be configured to determine the handling instructions. It should be understood that these example embodiments are illustrative, and therefore should not be construed as being limiting in any way.

According to various embodiments of the concepts and technologies disclosed herein, the packet management module 108 can be configured to generate, based on the determined, identified, or provided handling instructions, executable code (“code”) for implementing the one or more handling instructions. Thus, the code generated by the packet management module can, when executed by a computing device, cause the computing device to implement the handling instructions (e.g., for routing traffic, multiplexing/de-multiplexing traffic, implementing security protocols, combinations thereof, or the like).

The packet management module 108 can be configured to embed the code in the data packets 110 associated with the traffic. Thus, the packet management module 108 can be configured to modify the traffic to include data packets 110 that can include, inter alia, headers, payloads, code, and/or other data. The code included in the data packets 110 generated by (and/or operated on by) the packet management module 108 can be configured to cause a device that receives the data packets 110, upon executing the code, to implement one or more of the handling instructions. It can be appreciated that in various embodiments of the concepts and technologies disclosed herein, the identification of the destination devices 112 or next hops for the data packets 110 can continue to be stored in a header of the data packets 110 and therefore may not be identified in the code according to various embodiments of the concepts and technologies disclosed herein. It should be understood that this example is illustrative, and therefore should not be construed as being limiting in any way.

Thus, in some embodiments of the concepts and technologies disclosed herein, the server application 106 can generate and/or initiate transmission of the data packets 110. The packet management module 108 can be configured to determine, for the data packets 110, one or more handling instructions for one or more entities between the application server 102 and the destination device(s) 112; and to generate the code for causing the one or more devices to implement the determined handling instructions. In one contemplated example implementation of the concepts and technologies disclosed herein, the server application 106 may be used by a user to generate two copies of an identical email message for delivery to two destination devices 112.

The packet management module 108 can be configured to detect the two copies of the email message and that the emails will traverse much of the same network route 114 before being delivered to different destination devices 112. Embodiments of the packet management module 108 can be configured to multiplex the data packets 110 associated with the two email messages and transmit the multiplexed data packets 110 across the routers 116 until a last of the routers 116 (e.g., the router 116N) de-multiplexes the data packets 110 associated with the two email messages and delivers the two email messages to respective destination devices 112. It should be understood that this example is illustrative, and therefore should not be construed as being limiting in any way.

According to various embodiments of the concepts and technologies disclosed herein, the packet management module 108 can be configured to cause the application server 102 to communicate with the packet management service 118 and/or to access one or more packet management models 122 at the server computer 120 via an application programming interface (“API”) 124 exposed by the server computer 120. It should be understood that in various embodiments, a user's device or other entity that can execute an application that generates the data packets 110 can execute the packet management module 108 (or similar functionality) to manage how the data packets 110 are to be routed and/or handled. Furthermore, the API 124 can make these and/or other adjustments or modifications in some embodiments. Thus, it can be appreciated that the packet management module 108 can correspond, in various embodiments of the concepts and technologies disclosed herein, to a toolkit or the like for accessing functionality at another device (e.g., the server computer 120). It should be understood that this example is illustrative, and therefore should not be construed as being limiting in any way.

The packet management models 122 can define, for one or more types of traffic, handling instructions that have been and/or should be implemented. Thus, it can be appreciated that the packet management models 122 can correspond, in some embodiments, to one or more traffic handling policies; one or more traffic handling histories; or the like. Thus, in some embodiments of the concepts and technologies disclosed herein, the packet management module 108 can be configured to access, via the API 124 and/or other functionality, the one or more packet management models 122 to determine what handling instructions should apply for the one or more data packets 110 of the traffic without performing analysis of its own. It should be understood that this example is illustrative, and therefore should not be construed as being limiting in any way.

The packet management models 122 can be accessed, in some embodiments, by the packet management service 118 and/or the packet management module 108, while in some other embodiments the packet management models 122 do not exist and/or are not used. In some embodiments, the packet management models 122 can be created and/or updated by the packet management module 108 and/or the packet management service 118 based on handling instructions determined by the packet management module 108 and/or the packet management service 118.

As such, it can be appreciated that one or more of the devices illustrated and described in FIG. 1 including the application server 102, the destination devices 112, the routers 116, the server computer 120, or other devices can provide a feedback mechanism or feedback functionality for reporting routing information for the data packets 110 and that feedback can be used by the packet management module 108 and/or the packet management service 118 to create, update, and/or remove one or more packet management models 122. It should be understood that this example is illustrative, and therefore should not be construed as being limiting in any way.

The data packets 110 can be transmitted by the application server 102 to one or more routers 116 associated with a network route 114. As noted above, the data packets 110 can include code, in some embodiments, when received by a first of the routers 116 associated with the network route 114, and the routers 116 can be configured to recognize and execute the code in the data packets 110 (e.g., via a packet management module 108 or similar functionality executed by the routers 116, by accessing the packet management service 118 via the API 124, or the like) to implement the handling instructions.

In some other embodiments of the concepts and technologies disclosed herein, the data packets 110 can be generated by the server application 106 and received by a router 116 associated with the network route 114 and the router 116 can execute the packet management module 108 (or similar functionality) to perform the operations illustrated and described above for analyzing the data packets 110, determining handling instructions, generating code for implementing the handling instructions, and appending or embedding the code in the data packets 110. Thus, some embodiments of the concepts and technologies disclosed herein can implement the functionality illustrated and described herein for packet-based network control by routers 116 that can execute the packet management module 108 or similar functionality and/or that can access the packet management service 118. It should be understood that these examples are illustrative, and therefore should not be construed as being limiting in any way.

According to some embodiments of the concepts and technologies disclosed herein, the routers 116 can be configured to receive the data packets 110 with the code and to implement the code at the routers 116 and/or to communicate with the packet management service 118 to implement the handling instructions. In some embodiments, the operating environment 100 can include an orchestration service 126 that can communicate with the routers 116 and/or the server computer 120. Thus, in some embodiments, as noted above, the packet management module(s) 108 executed by one or more of the application server 102 and/or the routers 116 can be configured to communicate with the orchestration service 126 (directly and/or via the packet management service 118) to implement some types of handling instructions such as, for example, instructions for altering operation of one or more of the routers 116, implementing and/or orchestrating additional routers 116, implementing security settings or configurations along the network route 114, multiplexing and/or de-multiplexing of some or all of the data packets 110, combinations thereof, or the like. Thus, it can be appreciated that the data packets 110 can include code for altering the topology of the network route 114 (e.g., by orchestrating new routers 116 or other devices) as well as altering operation of one or more devices associated with the network route 114. It should be understood that this example is illustrative, and therefore should not be construed as being limiting in any way.

In practice, the server application 106 can generate and/or transmit data packets 110 to one or more destination devices 112 via a network route 114. The network route 114 can include one or more router 116. The routers 116 that correspond to the network route 114 can be configured in some embodiments to access the server computer 120 via the API 124 and/or other functionality. The application server 102, the routers 116, and/or the server computer 120 can host and/or execute a packet management module 108, packet management application, and/or packet management service 118 that can be configured to determine handling instructions for the data packets 110 when traversing the network route 114, to generate executable code that captures these handling instructions, and embed or append the code to the data packets 110. The code can be executable by the routers 116 and/or other network devices to alter handling of the data packets 110 by the routers 116. In some example embodiments, the network route 114 can be altered to impose security protocols and/or configurations based on the code; to have its topology altered based on the code (e.g., via calling the packet management service 118 and/or the orchestration service 126); to have operations of the routers 116 altered based on the code (e.g., multiplexing, de-multiplexing, capacity changes, QoS changes, etc.); and/or the like.

In some embodiments, application server 102 can execute the package management module 108 and the packet management module 108 can generate and embed the code in the data packets 110 before transmission. In some other embodiments, the routers 116 can execute the package management module 108 and/or similar functionality and the routers 116 can generate and embed the code in the data packets 110 after receipt. In yet other embodiments, the routers 116 can be configured to call functionality of a packet management service 118 and/or other functionality for generating and/or embedding the code in the data packets 110 and the server computer 120, the orchestration service 126, and/or the routers 116 can be configured to implement operations as directed by the code. Thus, it should be understood that FIG. 1 shows aspects of multiple contemplated embodiments of the concepts and technologies disclosed herein and therefore should not be construed as being limiting in any way.

The code included in the data packets 110 can be implemented by the routers 116 in some embodiments to alter the configuration of the routers 116. Thus, the code can cause the routers 116 to modify how traffic is routed by the routers 116, to activate and/or deactivate multiplexing and/or de-multiplexing, to apply security configurations and/or protocols to the traffic associated with the data packets 110, and/or to otherwise alter the operation of the routers 116. In some embodiments, the orchestration service 126 can be configured to alter a network topology (e.g., instantiating, deactivating, and/or modifying network devices or functions) and/or functions of the existing network topology based on the code. The orchestration service 126 can be called, in some embodiments, by the packet management module 108, by the packet management service 118, and/or by the routers 116. The routers 116 and/or the orchestration service 126 can implement the handling instructions, route and/or otherwise handle the data packets 110 in accordance with handling instructions, and provide feedback in some embodiments to the packet management service 118.

In some embodiments, the packet management service 118 can access one or more packet management models 122 to determine handling instructions for the data packets 110. The packet management models 122 can be used to reflect how similar or identical traffic has been routed in the past, in some embodiments, or to define handling instructions for some types of traffic (regardless of past handling). Thus, the packet management service 118 and/or the packet management module 108 can be configured to route traffic based on independent determinations relating to the data packets 110 and/or based on the packet management models 122. It should be understood that this example is illustrative, and therefore should not be construed as being limiting in any way.

The data packets 110 can be routed to the one or more destination devices 112 by the routers 116 and feedback can be provided to the packet management service 118.

In some embodiments, the packet management service 118 can update the packet management models. Thus, it can be appreciated that the data packets 110 can include code that can alter execution of devices and/or functions associated with a network route 114 and that the packet management models 122 can be updated based on the handling of the data packets 110. It should be understood that this example is illustrative, and therefore should not be construed as being limiting in any way.

FIG. 1 illustrates one application server 102, one network 104, two destination devices 112, one network route 114, three routers 116, one server computer 120, and one orchestration service 126. It should be understood, however, that various implementations of the operating environment 100 can include zero, one, or more than one application server 102; one or more than one network 104; one, two, or more than two destination devices 112; one or more than one network route 114; one, two, three, or more than three routers 116; zero, one, or more than one server computer 120; and one or more than one orchestration service 126. As such, the illustrated embodiment should be understood as being illustrative, and should not be construed as being limiting in any way.

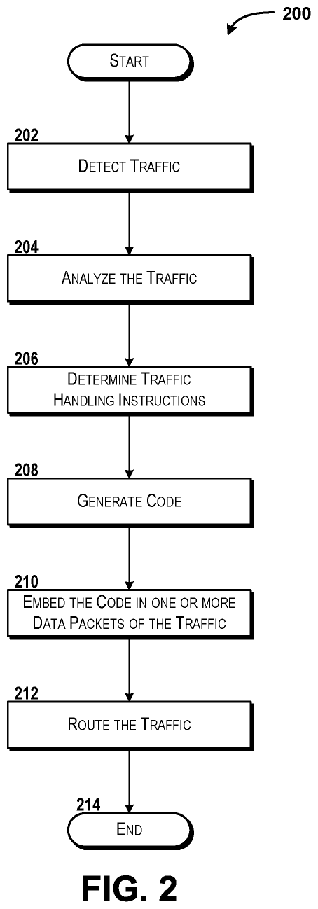

Turning now to FIG. 2, aspects of a method 200 for implementing packet-based traffic control at an application server 102 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the application server 102, the routers 116, and/or the server computer 120, to perform one or more operations and/or causing the processor to direct other components of the computing system or device to perform one or more of the operations.

For purposes of illustrating and describing the concepts of the present disclosure, the method 200 is described herein as being performed by the application server 102 via execution of one or more software modules such as, for example, the packet management module 108. It should be understood that additional and/or alternative devices and/or network nodes can provide the functionality described herein via execution of one or more modules, applications, and/or other software including, but not limited to, the packet management module 108. Thus, the illustrated embodiments are illustrative, and should not be viewed as being limiting in any way.

The method 200 begins at operation 202. At operation 202, the application server 102 can detect traffic associated with the server application 106. According to various embodiments of the concepts and technologies disclosed herein, the packet management module 108 can be executed by the application server 102 to monitor the server application 106 and/or data transmissions by the application server 102. Thus, operation 202 can correspond to the packet management module 108 detecting a data transmission associated with the server application 106 and/or the application server 102. It should be understood that this example is illustrative, and therefore should not be construed as being limiting in any way.

According to various embodiments of the concepts and technologies disclosed herein, the detection of traffic can include detecting the creation and/or transmission of one or more data packets 110. The data packets 110 can include almost any type of data and therefore can correspond to application data, messages (instant messages, email messages, text messages, etc.), video data, audio data, navigation data, and/or almost any other type of data. According to various embodiments of the concepts and technologies disclosed herein, the packet management module 108 can be configured to detect the data packets 110 before transmission of the data packets 110 has been completed (e.g., before the data packets 110 have left the application server 102). It should be understood that this example is illustrative, and therefore should not be construed as being limiting in any way. In some other embodiments, packet level information may be inferred by the connectivity data (e.g., source ports, destination ports, source addresses, destination addresses, or the like) to indicate the type of traffic and/or to use that information for detection purposes. For example, the conveyance of data to a block-chain server or ledger to convey the transference of a digital currency, metaverse (or digitally represented) item, or other non-fungible token (NFT) may be detected through inference of connectivity data. With no loss of generality, this inference-based detection may be considered equivalent to the packet management module 108 and executed before further transmission of the data packet(s) 110. It should be understood that this example is illustrative, and therefore should not be construed as being limiting in any way.

From operation 202, the method 200 can proceed to operation 204. At operation 204, the application server 102 can analyze the traffic detected in operation 202. In operation 204, the application server 102 can analyze one or more data packets 110 associated with the traffic. This analysis can correspond to the application server 102 determining handling instructions for the data packets 110. Thus, the application server 102 can be configured to determine, for the data packets 110, one or more destination devices 112 associated with the data packets 110; next hops for the data packets 110; security protocols and/or configurations to be used for transmission of the data packets 110; network configurations and/or topologies to be used for transmission of the data packets 110; multiplexing and/or de-multiplexing settings to be used for transmission of the data packets 110; combinations thereof; or the like.

In some embodiments of the concepts and technologies disclosed herein, the application server 102 can be configured to communicate with a packet management service 118 in association with operation 204. Thus, for example, the application server 102 can be configured to access, e.g., via the API 124, one or more packet management models 122 to determine handling instructions for the traffic. This determination can be based, in some embodiments, upon a type of traffic associated with the traffic, past handling of similar or identical traffic, combinations thereof, or the like. Thus, it can be appreciated that the analysis of operation 204 can be performed by the application server 102 directly (e.g., via execution of the packet management module 108) and/or via accessing the server computer 120 (e.g., via the API 124) to invoke and/or access functionality associated with the packet management service 118 and/or the packet management models 122. It should be understood that these examples are illustrative, and therefore should not be construed as being limiting in any way.

From operation 204, the method 200 can proceed to operation 206. At operation 206, the application server 102 can determine traffic routing and/or transmission needs and/or routing or transmission preferences based on the analysis of operation 204. Thus, it can be appreciated that operation 206 can correspond to the application server 102 determining (e.g., via execution of the package management module 108) or receiving information identifying (e.g., via interactions with the packet management service 118 and/or packet management models 122) the handling instructions for the traffic associated with the data packets 110.

According to various embodiments of the concepts and technologies disclosed herein, the information used to determine the handling instructions can include, but is not limited to, an expected amount of data to be generated by the server application 106 in association with this traffic (or stream or burst of traffic); a determination of a proximity between the server application 106 and one or more destination devices 112 (e.g., a number of hops, subnets, or the like along the network route 114); an expected amount of time (e.g., a duration) for which the traffic will be generated; a source type associated with the traffic (e.g., a data type, expected size of data, expected flows, expected sources, expected destination devices 112, etc.); and/or any special needs associated with the traffic and/or the transmission thereof (e.g., security needs, router needs, repeating, merging, self-destruction of the data after transmission, priority commitments, QoS commitments, etc.). These and/or other considerations can be determined based on analysis of the traffic being generated (e.g., the data packets 110) and/or based on one or more of the packet management models 122. Because other handling needs can be determined in accordance with the concepts and technologies disclosed herein, it should be understood that these examples are illustrative, and therefore should not be construed as being limiting in any way.

From operation 206, the method 200 can proceed to operation 208. At operation 208, the application server 102 can generate code for insertion into one or more data packets 110 associated with the traffic detected in operation 202. The code generated and/or embedded or inserted into the data packets 110 can include executable code that, when executed by one or more devices, cause those one or more devices to perform operations for realizing the handling instructions. Thus, for example, if the handling instructions indicate that some traffic should be multiplexed by a first router 116A and de-multiplexed by a second router 116B, the code can include executable code that, when executed by the first router 116A, causes the first router 116A to multiplex two or more of the data packets 110 and executable code that, when executed by the second router 116B, causes the second router 116B to de-multiplex the resulting multiplexed data packets 110 to obtain two or more data packets 110. It should be understood that this example is illustrative, and therefore should not be construed as being limiting in any way.

As noted above with reference to operations 204-206, the functionality of operation 208 can correspond to the application server 102 generating the code (e.g., via execution of the package management module 108) or to the application server 102 receiving the code (e.g., via interactions with the packet management service 118 and/or other entities) to create the code. It should be understood that these examples are illustrative, and therefore should not be construed as being limiting in any way.

From operation 208, the method 200 can proceed to operation 210. At operation 210, the application server 102 can embed the code in the data packets 110 associated with the traffic. According to various embodiments of the concepts and technologies disclosed herein, the application server 102 can embed the code in the data packets 110 prior to transmission of the data packets 110 to a next hop (e.g., a first of the routers 116). It should be understood that this example is illustrative, and therefore should not be construed as being limiting in any way.

From operation 210, the method 200 can proceed to operation 212. At operation 212, the application server 102 can route the traffic detected in operation 202. The data packets 110 can be routed to a next hop or first destination (e.g., one of the routers 116). It can be appreciated that the data packets 110 can include the code generated in operation 208.

From operation 212, the method 200 can proceed to operation 214. The method 200 can end at operation 214.

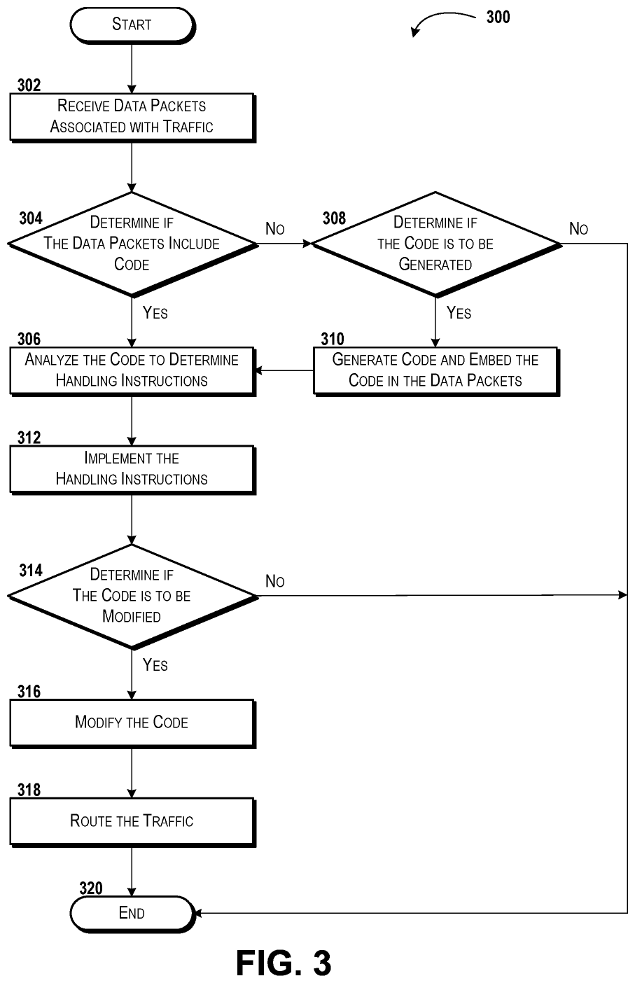

Turning now to FIG. 3, aspects of a method 300 for implementing packet-based traffic control at a network router will be described in detail, according to an illustrative embodiment. For purposes of illustrating and describing the concepts of the present disclosure, the method 300 is described herein as being performed by the router 116 via execution of one or more software modules such as, for example, the packet management module 108. It should be understood that additional and/or alternative devices and/or network nodes can provide the functionality described herein via execution of one or more modules, applications, and/or other software including, but not limited to, the packet management module 108. Thus, the illustrated embodiments are illustrative, and should not be viewed as being limiting in any way.

The method 300 begins at operation 302. At operation 302, the router 116 can receive one or more data packets 110 associated with traffic. As noted above, the data packets 110 can be generated and/or transmitted by the server application 106 and/or other devices or functionality. In some embodiments of the method 300, the data packets 110 received in operation 302 may not include code and instead can include only a header, payload, and optionally some other data. Thus, it can be appreciated that embodiments of the method 300 can be performed by the router 116 for data packets 110 that include the code and/or for data packets 110 that do not include the code.

From operation 302, the method 300 can proceed to operation 304. At operation 304, the router 116 can determine if the data packets 110 received in operation 304 include code. The router 116 can analyze the data packets 110 and determine if the code is embedded in and/or otherwise included with the data packets 110.

If the router 116 determines, in operation 304, that the data packets 110 received in operation 302 include the code, the method 300 can proceed to operation 306. At operation 306, the router 116 can analyze the code included in the data packets 110 to determine handling instructions that can identify how the data packets 110 are to be handled. In some embodiments of the concepts and technologies disclosed herein, the routers 116 can call and/or invoke the packet management service 118 to determine how the data packets 110 are to be handled. Thus, for example, the routers 116 can access the packet management models 122 (directly or via the packet management service 118) to determine handling instructions for the data packets 110.

As explained above, the code can define router configurations and/or settings to be applied to the routers 116 for the data packets 110; security configurations and/or settings to be applied to the routers 116 for the data packets 110; network topologies and/or topology changes to be applied along the network route 114 during routing of the data packets 110; multiplexing and/or de-multiplexing operations to be performed during routing of the data packets 110; combinations thereof; or the like.

If the router 116 determines, in operation 304, that the data packets 110 received in operation 302 do not include the code (e.g., for embodiments in which the routers 116 generate the code), the method 300 can proceed to operation 308. At operation 308, the router 116 can determine if the code is to be generated for the data packets 110. In some embodiments of the concepts and technologies disclosed herein, normal applications and/or data flows can be routed in accordance with best practices across the network route 114 without using executable code as illustrated and described herein. As such, the determination of operation 308 can be made, in some embodiments, by determining whether the data packets 110 are associated with a normal application or data flow and/or by determining that a user or application has not requested special handling that would cause the handling to differ from the typical flow.

The determination that a departure from the typical flow is to be made can result from determining that a specified QoS or quality of experience (“QoE”) is to apply to the data; by determining that certain security protocols apply to the traffic; by determining that efficiencies and/or inefficiencies of various transmission techniques suggest a change to the transmission approach; and/or other considerations as illustrated and described herein.

In some embodiments, the router 116 can be configured to determine that the code should be generated automatically if the router 116 determines that the data packets 110 do not include the code when received. In some other embodiments, the determination of operation 308 can be based on analysis of the traffic associated with the data packets 110 and/or based on one or more packet management models 122 as noted above. For example, the router 116 may determine that certain types of traffic are to be transmitted at a certain QoS, with certain security protocols, using multiplexing, etc. Thus, the router 116 can determine whether or not code is to be embedded in this traffic (e.g., these data packets 110) in operation 308. Because this determination can be made in additional and/or alternative manners, it should be understood that these examples are illustrative, and therefore should not be construed as being limiting in any way.

If the router 116 determines, in operation 308, that code is to be generated for the data packets 110 received in operation 302, the method 300 can proceed to operation 310. At operation 310, the router 116 can generate code for insertion into one or more data packets 110 associated with the traffic detected in operation 302. The code generated and/or embedded or inserted into the data packets 110 can include executable code that, when executed by one or more devices, can cause those one or more devices to perform operations for implementing determined or specified handling instructions. Thus, for example, if the handling instructions indicate that some traffic should be transmitted at a particular QoS, the code can include executable code that, when executed by one or more of the routers 116, causes the one or more routers 116 to apply the defined QoS to transmissions of the data packets 110. It should be understood that this example is illustrative, and therefore should not be construed as being limiting in any way.

The functionality of operation 308 can correspond to the router 116 generating the code (e.g., via execution of the package management module 108) or to the router 116 obtaining or receiving the code from other devices that can generate the code on request (e.g., the packet management service 118 at the server computer 120). Thus, some embodiments of the method 300 can include the router 116 calling or invoking the packet management service 118 to create the code based on one or more packet management models 122 and/or based on other considerations. It should be understood that these examples are illustrative, and therefore should not be construed as being limiting in any way.

From operation 310, the method 300 can proceed to operation 306. As noted above, at operation 306, the router 116 can analyze the code included in the data packets 110 to determine the handling instructions. In some embodiments of the concepts and technologies disclosed herein, the routers 116 can use the handling instructions prior to inserting the code in the data packets 110, and therefore the method 300 can flow from operation 310 to operation 312 below in some embodiments (though this is not shown in FIG. 3). As such, the illustrated embodiment is illustrative and should not be construed as being limiting in any way.

From operation 306, the method 300 can proceed to operation 312. At operation 312, the router 116 can implement the determined handling instructions. According to various embodiments of the concepts and technologies disclosed herein, operation 312 can correspond to the routers 116 executing the code to implement the routing instructions. Thus, operation 312 can include the routers 116 multiplexing two or more of the data packets 110; modifying and/or applying network and/or router configurations and/or settings to the routers 116; modifying and/or applying security configurations, settings, and/or protocols to the routers 116; de-multiplexing one or more multiplexed data packets 110; combinations thereof, or the like.

In some embodiments, the routers 116 can be configured to invoke or call functionality of the orchestration service 126 in accordance with operation 312. For example, the routers can call or invoke the orchestration service 126 to instantiate devices or functions along the network route 114; to alter operation and/or configurations of one or more devices on the network route 114; combinations thereof; or the like. As such, it can be appreciated that the routers 116 can perform the operations associated with operation 312 and/or can interact with the orchestration service 126 directly and/or via interactions with the packet management service 118 and/or the packet management models 122. It should be understood that these examples are illustrative, and therefore should not be construed as being limiting in any way.

From operation 312, the method 300 can proceed to operation 314. At operation 314, the router 116 can determine if code of the data packets 110 is to be added, updated, removed, or otherwise modified. In some embodiments of the concepts and technologies disclosed herein, the routers 116 can be configured to update the code embedded in the data packets 110 during transmission of the data packets 110 across the network route 114. For example, the code embedded in the data packets 110 can specify that a next router 116 is to multiplex the data packets 110. After multiplexing the data packets 110, the routers 116 can update or insert new code instructing a particular router 116 to de-multiplex the data packets 110. It should be understood that this example is illustrative and should not be construed as being limiting in any way. At any rate, it should be understood that operation 314 can correspond to the routers 116 determining if the code should be updated, removed, supplemented, combinations thereof, or the like.

If the router 116 determines, in operation 314, that the code of the data packets 110 is to be modified (e.g., that code is to be added, updated, removed, etc.), the method 300 can proceed to operation 316. At operation 316, the router 116 can modify the code. Operation 316 also can include the router 116 adding, substituting, and/or removing code to and/or from the data packets 110. The modified code can include new code, replacement code, removed code, or the like. Operation 316 also can include the router 116 embedding the code in the data packets 110. It should be understood that this example is illustrative, and therefore should not be construed as being limiting in any way.

From operation 316, the method 300 can proceed to operation 318. At operation 318, the router 116 can route the traffic (e.g., the data packets 110) to a next hop or destination device 112. According to various embodiments of the concepts and technologies disclosed herein, the router 116 can determine a next hop or destination device 112 based on the header of the data packets 110. Thus, it can be appreciated that in some embodiments the routing of the data packet 110 by the router 116 can be based on the header while the handling instructions can be based on the code. In other words, in some embodiments of the concepts and technologies disclosed herein the routing of the data packets 110 is not based on the code while how the routing occurs can be based on the code. It should be understood that this example is illustrative, and therefore should not be construed as being limiting in any way.

From operation 318, the method 300 can proceed to operation 320. The method 300 also can proceed to operation 320 if the router 116 determines, in operation 314, that code is not to be generated for the data packets 110. The method 300 also can proceed to operation 320 if the router 116 determines, in operation 314, that the code of the data packets 110 is not to be modified (e.g., that code is not to be added, updated, removed, etc.). The method 300 can end at operation 320.

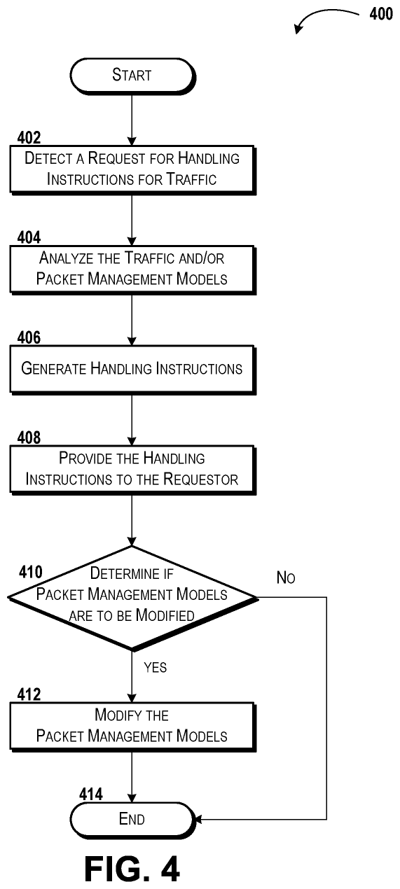

Turning now to FIG. 4, aspects of a method 400 for implementing packet-based traffic control using a packet management service 118 will be described in detail, according to an illustrative embodiment. For purposes of illustrating and describing the concepts of the present disclosure, the method 400 is described herein as being performed by the server computer 120 via execution of one or more software modules such as, for example, the packet management service 118. It should be understood that additional and/or alternative devices and/or network nodes can provide the functionality described herein via execution of one or more modules, applications, and/or other software including, but not limited to, the packet management service 118. Thus, the illustrated embodiments are illustrative, and should not be viewed as being limiting in any way.

The method 400 begins at operation 402. At operation 402, the server computer 120 can detect a request to obtain handling instructions for traffic including one or more data packets 110. As can be appreciated with reference to the description above, the request detected in operation 402 can correspond to a device, application, or module invoking or calling the functionality of the packet management service 118 (e.g., via the API 124 exposed by the server computer 120). Thus, it can be appreciated that the request obtained in operation 402 can come from the application server 102 or one or more of the routers 116. The request (or service call) obtained in operation 402 can identify the traffic (e.g., the one or more data packets 110) and request routing instructions for those data packets 110 according to various embodiments. It should be understood that this example is illustrative, and therefore should not be construed as being limiting in any way.

From operation 402, the method 400 can proceed to operation 404. At operation 404, the server computer 120 can analyze the traffic (e.g., the data packets 110) and one or more models such as the packet management models 122. The packet management models 122 can represent routing instructions for the data packets 110 and/or for traffic that is similar (or even identical) to traffic associated with the data packets 110. For example, a packet management model 122 may define a multiplexing/de-multiplexing plan for data packets 110 similar or even identical to the data packets 110 associated with the traffic for which the request to obtain handling instructions was received in operation 402.

As explained above, the packet management models 122 can define various aspects of the handling instructions such as security protocols to enforce on the data packets 110; priority to apply to the data packets 110; multiplexing and/or de-multiplexing operations to perform on the data packets 110; network configurations to apply or use during routing of the data packets 110; combinations thereof, or the like. Thus, operation 404 can include analyzing the data packets 110 and/or the traffic associated with the data packets 110 and analyzing the packet management models 122 to determine how the data packets 110 should be handled. It should be understood that this example is illustrative, and therefore should not be construed as being limiting in any way.

From operation 404, the method 400 can proceed to operation 406. At operation 406, the server computer 120 can generate handling instructions for the one or more data packets 110. In operation 406, the server computer 120 can determine how the data packets 110 will be handled including security protocols; network configurations; router configurations; priority schemes; network topologies and/or topology changes (e.g., virtual network functions (“VNFs”) to start, modify, stop, etc.); multiplexing/de-multiplexing operations; combinations thereof; or the like to be applied to the network route 114 for routing the data packets 110.

From operation 406, the method 400 can proceed to operation 408. At operation 408, the server computer 120 can provide the handling instructions to the entity that requested the handling instructions. Thus, it can be appreciated that in operation 408 the handling instructions can be provided to the application server 102 and/or one or more of the routers 116. In some embodiments, operation 408 can correspond to the server computer 120 generating code corresponding to the handling instructions generated in operation 406 and providing the code to the application server 102 and/or the one or more routers 116 for insertion into the data packets 110. It should be understood that these examples are illustrative, and therefore should not be construed as being limiting in any way.

From operation 408, the method 400 can proceed to operation 410. At operation 410, the server computer 120 can determine if the packet management models 122 are to be modified. According to various embodiments of the concepts and technologies disclosed herein, a quality validation module or other functionality can monitor transmission of the data packets 110 across the network route 114 to observe the traversal of the data packets 110 and compare that traversal to the encoded actions and/or priority requirements (e.g., multiplexing actions, QoS commitments, topology changes, etc.). The server computer 120 can be configured to validate execution of the actions and/or determine and/or store action alternatives to be considered or used in a next traffic flow that implicates the packet management model 122 at issue. As such, the packet management models 122 can be updated based on experiential learning of the packet management service 118 in some embodiments. It should be understood that this example is illustrative, and therefore should not be construed as being limiting in any way.

According to some other embodiments of the concepts and technologies disclosed herein, one or more of the application server 102, the destination devices 112, the routers 116, and/or the orchestration service 126 can be configured to provide feedback to the packet management service 118 regarding handling of the data packets 110. Additionally, and/or alternatively, the server computer 120 can be configured to monitor flow of the data packets 110 across the network route 114 via direct or indirect observations (e.g., via a network monitor and/or via reports from one or more of the endpoints (e.g., the application server 102 and the destination device(s) 112) and/or the routers 116). This feedback and/or observed information can reveal explicitly or implicitly, for example based on analysis of feedback and/or observed information, efficiencies and/or inefficiencies in the handling of the data packets 110.

As such, operation 410 can correspond to the server computer 120 analyzing observed data and/or feedback to identify any efficiencies and/or inefficiencies in handling the data packets 110 in accordance with the determined handling instructions and/or the code. In one contemplated non-limiting example, the handling instructions may be based on one or more of the packet management models 122 and may indicate that two or more data packets 110 should be multiplexed at a first router 116A and de-multiplexed at a last router 116N and the data packets 110 may be routed in accordance with this determination. Based on feedback and/or observed inefficiencies, however, the server computer 120 may determine that the two or more data packets 110 should be multiplexed at a first router 116A and de-multiplexed at a second router 116B instead of the last router 116N. Thus, in this example the server computer 120 can update the packet management models 122 to indicate this determined change. It should be understood that this example is illustrative, and therefore should not be construed as being limiting in any way.

If the server computer 120 determines, in operation 410, that the packet management models 122 are to be modified, the method 400 can proceed to operation 412. At operation 412, the server computer 120 can modify one or more of the packet management models 122. Thus, the server computer 120 can determine what modifications are to be made to the packet management models 122 (e.g., to add one or more packet management model, to update one or more packet management model, to delete one or more packet management model, combinations thereof, or the like) and implement the change by modifying the packet management models 122. It can be appreciated that in some embodiments, the server computer 120 can cause other devices or entities to update the packet management models 122, and therefore that operation 412 can correspond to the server computer 120 triggering or prompting other devices or entities to make these changes. It should be understood that this example is illustrative, and therefore should not be construed as being limiting in any way.

From operation 412, the method 400 can proceed to operation 414. The method 400 also can proceed to operation 414 if the server computer 120 determines, in operation 410 that the packet management models 122 are not to be modified. The method 400 can end at operation 414.

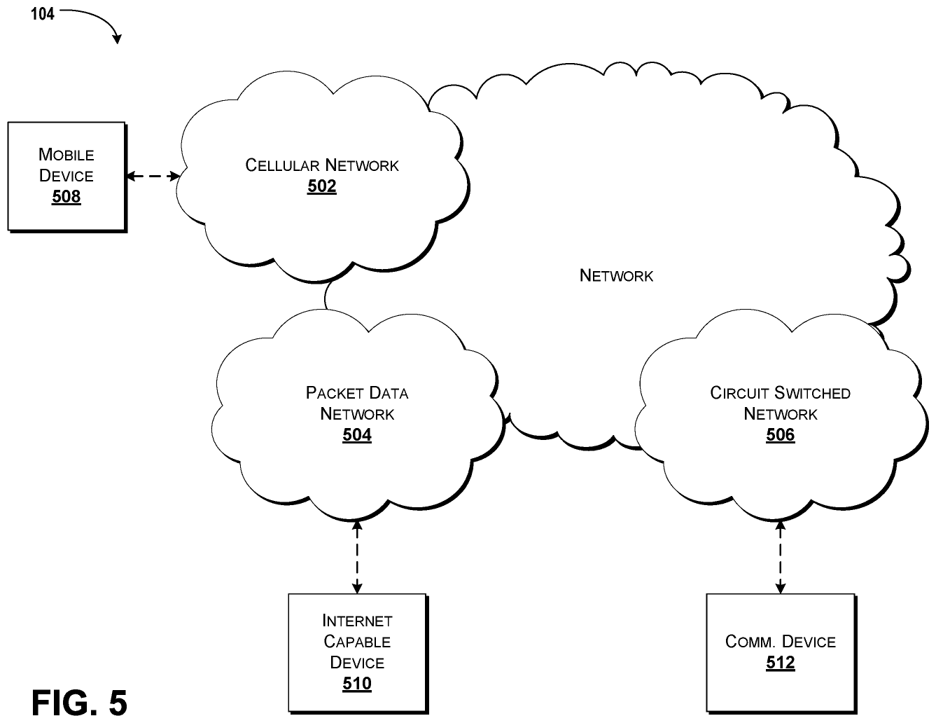

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSDPA), and HSPA+. The cellular network 502 also is compatible with 4G mobile communications standards, 5G mobile communications standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

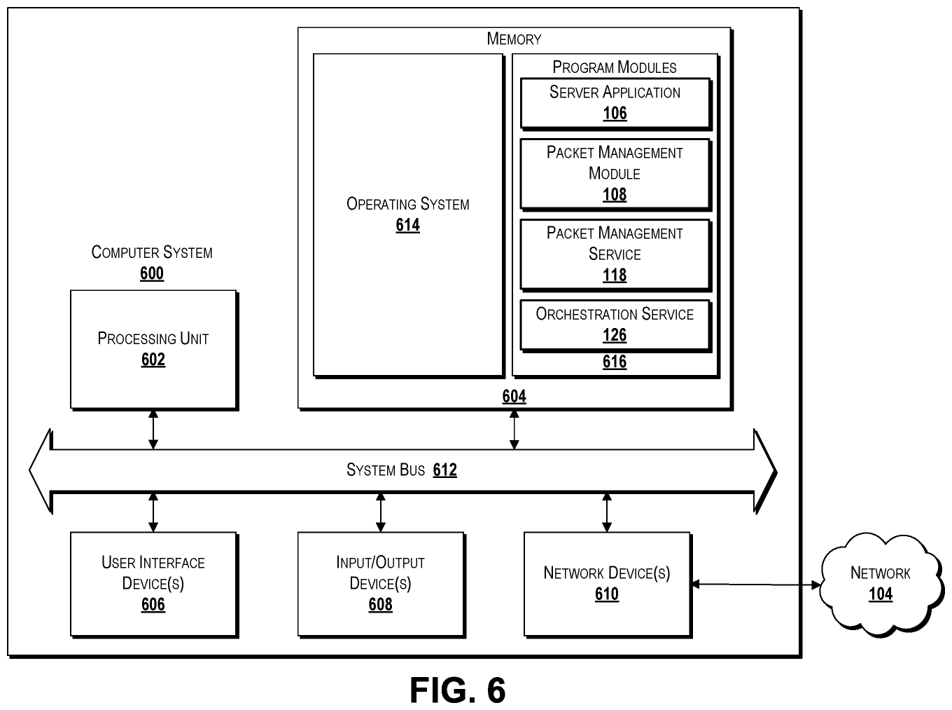

FIG. 6 is a block diagram illustrating a computer system 600 configured to provide the functionality described herein for enabling packet-based network delivery control and/or interacting with a packet management service 118, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the server application 106, the packet management module 108, the packet management service 118, and/or the orchestration service 126. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the data packets 110, the packet management models 122, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

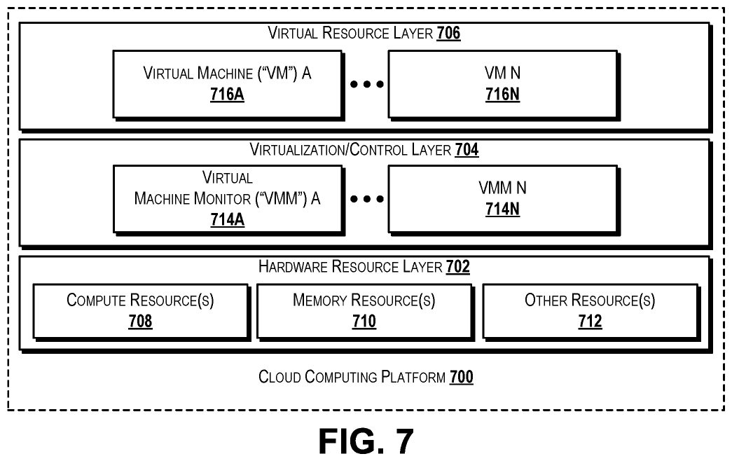

FIG. 7 illustrates an illustrative architecture for a cloud computing platform 700 that can be capable of executing the software components described herein for enabling and/or providing packet-based network delivery control and/or for interacting with the server application 106, the packet management module 108, the packet management service 118, and/or the orchestration service 126. Thus, it can be appreciated that in some embodiments of the concepts and technologies disclosed herein, the cloud computing platform 700 illustrated in FIG. 7 can be used to provide the functionality described herein with respect to the application server 102, the destination devices 112, the routers 116, the server computer 120, and/or the orchestration service 126.

The cloud computing platform 700 thus may be utilized to execute any aspects of the software components presented herein. Thus, according to various embodiments of the concepts and technologies disclosed herein, the server application 106, the packet management module 108, the packet management service 118, and/or the orchestration service 126 can be implemented, at least in part, on or by elements included in the cloud computing platform 700 illustrated and described herein. Those skilled in the art will appreciate that the illustrated cloud computing platform 700 is a simplification of but only one possible implementation of an illustrative cloud computing platform, and as such, the illustrated cloud computing platform 700 should not be construed as being limiting in any way.

In the illustrated embodiment, the cloud computing platform 700 can include a hardware resource layer 702, a virtualization/control layer 704, and a virtual resource layer 706. These layers and/or other layers can be configured to cooperate with each other and/or other elements of a cloud computing platform 700 to perform operations as will be described in detail herein. While connections are shown between some of the components illustrated in FIG. 7, it should be understood that some, none, or all of the components illustrated in FIG. 7 can be configured to interact with one another to carry out various functions described herein. In some embodiments, the components are arranged so as to communicate via one or more networks such as, for example, the network 104 illustrated and described hereinabove (not shown in FIG. 7). Thus, it should be understood that FIG. 7 and the following description are intended to provide a general understanding of a suitable environment in which various aspects of embodiments can be implemented and should not be construed as being limiting in any way.

The hardware resource layer 702 can provide hardware resources. In the illustrated embodiment, the hardware resources can include one or more compute resources 708, one or more memory resources 710, and one or more other resources 712. The compute resource(s) 708 can include one or more hardware components that can perform computations to process data, and/or to execute computer-executable instructions of one or more application programs, operating systems, services, and/or other software including, but not limited to, the server application 106, the packet management module 108, the routers 116, the packet management service 118, and/or the orchestration service 126 illustrated and described herein.

According to various embodiments, the compute resources 708 can include one or more central processing units (“CPUs”). The CPUs can be configured with one or more processing cores. In some embodiments, the compute resources 708 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 708 can include one or more discrete GPUs. In some other embodiments, the compute resources 708 can include one or more CPU and/or GPU components that can be configured in accordance with a co-processing CPU/GPU computing model. Thus, it can be appreciated that in some embodiments of the compute resources 708, a sequential part of an application can execute on a CPU and a computationally-intensive part of the application can be accelerated by the GPU. It should be understood that this example is illustrative, and therefore should not be construed as being limiting in any way.

In some embodiments, the compute resources 708 also can include one or more system on a chip (“SoC”) components. It should be understood that the SoC component can operate in association with one or more other components as illustrated and described herein, for example, one or more of the memory resources 710 and/or one or more of the other resources 712. In some embodiments in which an SoC component is included, the compute resources 708 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 708 can be or can include one or more hardware components arranged in accordance with an ARM architecture, available for license from ARM HOLDINGS of Cambridge, United Kingdom. Alternatively, the compute resources 708 can be or can include one or more hardware components arranged in accordance with an x86 architecture, such as an architecture available from INTEL CORPORATION of Mountain View, California, and others. Those skilled in the art will appreciate the implementation of the compute resources 708 can utilize various computation architectures and/or processing architectures. As such, the various example embodiments of the compute resources 708 as mentioned hereinabove should not be construed as being limiting in any way. Rather, implementations of embodiments of the concepts and technologies disclosed herein can be implemented using compute resources 708 having any of the particular computation architecture and/or combination of computation architectures mentioned herein as well as other architectures.

Although not separately illustrated in FIG. 7, it should be understood that the compute resources 708 illustrated and described herein can host and/or execute various services, applications, portals, and/or other functionality illustrated and described herein. Thus, the compute resources 708 can host and/or can execute the server application 106, the packet management module 108, the routers 116, the packet management service 118, and/or the orchestration service 126 or other applications or services illustrated and described herein.

The memory resource(s) 710 can include one or more hardware components that can perform or provide storage operations, including temporary and/or permanent storage operations. In some embodiments, the memory resource(s) 710 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 708, subject to the definition of “computer storage media” provided above (e.g., as excluding waves and signals per se and/or communication media as defined in this application).

Although not illustrated in FIG. 7, it should be understood that the memory resources 710 can host or store the various data illustrated and described herein including, but not limited to, the data packets 110, the packet management models 122, and/or other data, if desired. It should be understood that this example is illustrative, and therefore should not be construed as being limiting in any way.

The other resource(s) 712 can include any other hardware resources that can be utilized by the compute resources(s) 708 and/or the memory resource(s) 710 to perform operations. The other resource(s) 712 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 702 can be virtualized by one or more virtual machine monitors (“VMMs”) 714A-714N (also known as “hypervisors;” hereinafter “VMMs 714”). The VMMs 714 can operate within the virtualization/control layer 704 to manage one or more virtual resources that can reside in the virtual resource layer 706. The VMMs 714 can be or can include software, firmware, and/or hardware that alone or in combination with other software, firmware, and/or hardware, can manage one or more virtual resources operating within the virtual resource layer 706.

The virtual resources operating within the virtual resource layer 706 can include abstractions of at least a portion of the compute resources 708, the memory resources 710, the other resources 712, or any combination thereof. These abstractions are referred to herein as virtual machines (“VMs”). In the illustrated embodiment, the virtual resource layer 706 includes VMs 716A-716N (hereinafter “VMs 716”).

Based on the foregoing, it should be appreciated that systems and methods for packet-based network delivery control have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising:
receiving, at a router included in a network route, data packets associated with traffic generated by an application server, wherein the traffic is sent by the application server to a destination device via the network route,
determining, at the router, if executable code is to be generated for the data packets,
in response to a determination that the executable code is to be generated for the data packets, determining handling instructions for the data packets,
generating the executable code, wherein the executable code, when executed by the router, causes the router to transmit the data packets across the network route in accordance with the handling instructions, and
implementing the handling instructions at the router to transmit the data packets across the network route in accordance with the handling instructions.

2. The system of claim 1, wherein the computer-executable instructions, when executed by the processor, cause the processor to perform operations further comprising:
embedding the executable code in the data packets by adding the executable code to payloads of the data packets.

3. The system of claim 1, wherein the handling instructions comprise an indication of a quality of service to apply to transmission of the data packets across the network route.

4. The system of claim 1, wherein the handling instructions comprise a first instruction to multiplex at least two of the data packets at the router to obtain a data package, and a second instruction to de-multiplex the data package at a further router included in the network route.

5. The system of claim 1, wherein the handling instructions comprise a security configuration to apply across the network route for the data packets, wherein the security configuration comprises a security protocol.

6. The system of claim 1, wherein the handling instructions comprise a network topology to use for the network route, wherein the router invokes a packet management service via an application programming interface to cause the packet management service to trigger a topology change along the network route.

7. The system of claim 6, wherein the topology change is implemented by an orchestration service in communication with the packet management service.

8. The system of claim 1, wherein generating the executable code comprises requesting, via an application programming interface exposed by a computing device, a packet management service to provide the executable code.

9. The system of claim 8, wherein the packet management service generates the executable code based on an analysis of the data packets and a packet management model that defines handling instructions for a traffic type associated with the data packets.

10. A method comprising:
receiving, at a router included in a network route, data packets associated with traffic generated by an application server, wherein the traffic is sent by the application server to a destination device via the network route;
determining, at the router, if executable code is to be generated for the data packets;
in response to a determination that the executable code is to be generated for the data packets, determining handling instructions for the data packets;
generating the executable code, wherein the executable code, when executed by the router, causes the router to transmit the data packets across the network route in accordance with the handling instructions; and
implementing the handling instructions at the router to transmit the data packets across the network route in accordance with the handling instructions.

11. The method of claim 10, further comprising:
embedding the executable code in the data packets by adding the executable code to payloads of the data packets.

12. The method of claim 10, wherein the handling instructions comprise a network topology to use for the network route, wherein the router invokes a packet management service via an application programming interface to cause the packet management service to trigger a topology change along the network route, and wherein the topology change is implemented by an orchestration service in communication with the packet management service.

13. The method of claim 10, wherein generating the executable code comprises requesting, via an application programming interface exposed by a computing device, a packet management service to provide the executable code, and wherein the packet management service generates the executable code based on an analysis of the data packets and a packet management model that defines handling instructions for a traffic type associated with the data packets.

14. A computer storage medium having computer-executable instructions stored thereon that, when executed by a processor, cause the processor to perform operations comprising:
receiving, at a router included in a network route, data packets associated with traffic generated by an application server, wherein the traffic is sent by the application server to a destination device via the network route;
determining, at the router, if executable code is to be generated for the data packets;
in response to a determination that the executable code is to be generated for the data packets, determining handling instructions for the data packets;
generating the executable code, wherein the executable code, when executed by the router, causes the router to transmit the data packets across the network route in accordance with the handling instructions; and
implementing the handling instructions at the router to transmit the data packets across the network route in accordance with the handling instructions.

15. The computer storage medium of claim 14, wherein the computer-executable instructions, when executed by the processor, cause the processor to perform operations further comprising:
embedding the executable code in the data packets by adding the executable code to payloads of the data packets.

16. The computer storage medium of claim 14, wherein the handling instructions comprise an indication of a quality of service to apply to transmission of the data packets across the network route.

17. The computer storage medium of claim 14, wherein the handling instructions comprise a first instruction to multiplex at least two of the data packets at the router to obtain a data package, and a second instruction to de-multiplex the data package at a further router included in the network route.

18. The computer storage medium of claim 14, wherein the handling instructions comprise a security configuration to apply across the network route for the data packets, wherein the security configuration comprises a security protocol.

19. The computer storage medium of claim 14, wherein the handling instructions comprise a network topology to use for the network route, wherein the router invokes a packet management service via an application programming interface to cause the packet management service to trigger a topology change along the network route, and wherein the topology change is implemented by an orchestration service in communication with the packet management service.

20. The computer storage medium of claim 14, wherein generating the executable code comprises requesting, via an application programming interface exposed by a computing device, a packet management service to provide the executable code, and wherein the packet management service generates the executable code based on an analysis of the data packets and a packet management model that defines handling instructions for a traffic type associated with the data packets.
